(19) United States
(12) Patent Application Publication
(10) Pub. No.: US 2018/0216038 A1
(43) Pub. Date: Aug. 2, 2018

(54) DETERGENT PARTICLE COMPRISING POLYMER AND SURFACTANT

(71) Applicant: The Procter & Gamble Company, Cincinnati, OH (US)

(72) Inventors: Paul R. MORT, III, Cincinnati, OH (US); Mark Robert SIVIK, Mason, OH (US); Mark William HAMERSKY, HAMILTON, OH (US); Stephen Robert GLASSMEYER, CINCINNATI, OH (US); Guangzong ZHAO, BEIJING (CN); Rui SHEN, BEIJING (CN)

(21) Appl. No.: 15/880,586

(22) Filed: Jan. 26, 2018

Related U.S. Application Data
(60) Provisional application No. 62/451,113, filed on Jan. 27, 2017.

(51) Int. Cl. C11D 3/37; C11D 17/04; C11D 17/06; C11D 1/37; C11D 3/10

(52) U.S. Cl. CPC C11D 3/3723; C11D 17/044; C11D 17/06; C11D 1/29; C11D 3/10; C11D 3/3761; C11D 1/37

(57) ABSTRACT

A rheology-modified detergent particle comprising:
(a) from about 10 wt % to about 80 wt % alkoxylated alkyl sulfate anionic detersive surfactant;
(b) from about 0.5 wt % to about 20 wt % of a rheology modifier selected from the group consisting of a non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70, an N,N,N′,N′-tetra(2-hydroxyethyl)ethylenediamine, and mixtures thereof.

### FIELD OF THE INVENTION

The present invention provides a rheology-modified detergent particle, said particle comprising a mixture of specific surfactants and specific functional rheology modifier. The rheology-modified detergent particle is suitable for use in highly concentrated solid or granular dose forms. Surprisingly, it has been found that preferred rheology modifiers can also improve physical stability and flowability of dry detergent particles prior to use in detergent applications.

### BACKGROUND OF THE INVENTION

This invention advances the technology of solid-form detergents and other cleaning products relying on surfactants, especially compact dose forms having highly-concentrated surfactants. More specifically, the incorporation of specific functional rheology modifiers with specific surfactants has been found to reduce the viscosity and persistence of sticky intermediate phases that may occur on initial wetting of the solid-form detergent. As such, the current invention significantly aids dispersion, mitigating the risk of forming hexagonal phase or lump-gel residues on fabrics, even in cold-water or other stressed washing conditions. Further, for any lump-gels that may form, the viscosity reduction of the current invention significantly reduces their persistence. The net effect is to mitigate the occurrence of surfactant lump-gel residues that persist on fabrics through the wash.

Highly compact dose forms are desired from myriad perspectives, e.g., sustainability, convenience and efficiency. For detergent applications, compositions comprising highly concentrated anionic surfactants and blends thereof are often preferred. Especially preferred are anionic surfactants comprising alkylethoxysulfates (AES). However, there are challenges in both manufacturing and end-use of products comprising such concentrated surfactants.

An additional advantage of the current invention is to enable production of more highly-concentrated detergent particles, especially particles made as agglomerates or extrudates having a more concentrated surfactant paste precursor is advantageous. Use of preferred rheology modifiers allows for processing of more highly-concentrated surfactant paste. Further, preferred rheology modifiers can improve physical properties of highly-concentrated detergent particles.

While there are advantages in using concentrated surfactant paste in processing compact dose forms comprising detergent particles, highly-concentrated paste is problematic because its rheology is difficult to manage in processing equipment. The use of process-aid viscosity modifiers in the manufacture of concentrated surfactant paste is known. U.S. Pat. No. 4,412,945 discloses polyoxyethylene alkyl ether as a means of reducing viscosity of concentrated AES surfactant slurries while maintaining good phase stability. U.S. Pat. No. 4,482,470 and U.S. Pat. No. 5,045,238 disclose the use of polyglycol ethers, preferably polyethylene glycol (PEG) of MWT in the range of about 4000 to 12000 which can reduce the viscosity within a surfactant paste neutralization process operating above about 60° C. yet benefit the physical stability of solid dose forms at typical ambient temperatures.

Detergent particles comprising concentrated surfactants are useful in formulating compact dose forms. Formation of high active detergent particles, preferably AES particles, using a paste-agglomeration process is known. US20140366281 exemplifies concentrated surfactant paste, e.g., ≥70% active AES, as a binder in the agglomeration process.

Suitable molecules that have both detergent functionality and enable the making of a more highly-concentrated surfactant paste and a more highly concentrated detergent particle with improved physical properties include sorbitol ethoxylate, glycerol ethoxylate, sorbitan esters, TAE-80, polyethyleneimine (PEI), alkoxylated variants thereof, ethylene oxide-propylene oxide-ethylene oxide (EOₓ₁PO_{y}EOₓ₂) triblock copolymers wherein each of x₁ and x₂ is in the range of about 2 to about 140 and y is in the range of from about 15 to about 70, N,N,N′,N′-tetraethoxylethylenediamine, and mixtures thereof. Especially preferred as a functional rheology modifier are polyethyleneimine (PEI) and ethoxylated variants thereof, preferably non-quaternized ethoxylated polyethyleneimines, an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70, N,N,N′,N′-tetraethoxylethylenediamine, and mixtures thereof. While the use of polyethyleneimine (PEI) and its ethoxylated variants is known as a dispersant cleaning active, U.S. Pat. No. 4,548,744; and its further use as a suds stabilizer has been proposed, U.S. Pat. No. 8,759,276; there is no prior disclosure, to the inventors' knowledge, of its use of as a rheology modifier for detergent particles.

The current invention discloses the use of a functional rheology modifier that provides benefits as a processing aid for making a more highly-concentrated surfactant paste, which is then used to make a more highly concentrated detergent particle having improved physical properties; and it provides detergent active chemistry for improved cleaning performance. The current invention additionally discloses surprising physical stability and flowability benefits achieved in detergent particles comprising AES surfactants with preferred functional rheology modifiers.

### SUMMARY OF THE INVENTION

The present invention provides a rheology-modified detergent particle comprising:
(a) from about 10 wt % to about 80 wt % alkoxylated alkyl sulfate anionic detersive surfactant;
(b) from about 0.5 wt % to about 20 wt % of a rheology modifier selected from the group consisting of a non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70, an N,N,N′,N′-tetraethoxylethylenediamine, and mixtures thereof.

### DETAILED DESCRIPTION OF THE INVENTION

The present invention is directed to a rheology-modified detergent particle, said particle comprising from about 10 to 80 wt % specific anionic surfactant and about 0.5 wt % to 20 wt % specific functional rheology modifier. The rheology modifier is typically sufficiently micro-mixed with the anionic surfactant to substantially mitigate the risk of forming lump-gel residues in stressed washing conditions.

In further embodiments, the rheology-modified detergent particle of the present invention can include additional cleaning actives, while retaining adequate chemical and physical stability for handling and storage.

In yet further aspects, processes for making the rheology-modified detergent particle of the present invention are disclosed. Preferred process provides micro-mixing, even molecular-scale mixing, of functional rheology modifiers in concentrated surfactant phase structures, enabling the most effective reduction of viscosity, stickiness, and otherwise persistent behavior of partially-dissolved detergent as it is mixed with water in the washing process.

Finally, the present invention is directed to cleaning compositions and use thereof, preferably to highly concentrated solid or granular dose forms comprising a rheology-modified detergent particle. Depending on the product requirement, the rheology-modified detergent particle can be formulated as a primary source of surfactant in the product composition, as a source of a secondary co-surfactant, a source of blended surfactants, or as a multi-active source of surfactant and ancillary cleaning actives.

Rheology-modified detergent particle: The rheology-modified detergent particle comprises:
(a) from about 10 wt % to about 80 wt % alkoxylated alkyl sulfate anionic detersive surfactant;
(b) from about 0.5 wt % to about 20 wt % of a rheology modifier selected from the group consisting of a non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70, an N,N,N′,N′-tetraethoxylethylenediamine, and mixtures thereof.

Typically, the weight ratio of alkoxylated alkyl sulfate anionic detersive surfactant to rheology modifier is in the range of from 4:1 to 40:1.

The particle may comprise from about 15 wt % to about 60 wt %, or from 20 wt % to 40 wt % alkoxylated alkyl sulfate anionic detersive surfactant, or from 30 wt % to 80 wt % or even from 50 wt % to 70 wt % alkoxylated alkyl sulfate anionic detersive surfactant.

The particle may comprise alkylbenzene sulfonate, for example, linear alkylbenzene sulfonate (LAS). The particle may comprise from 1 wt % to 50 wt % alkylbenzene sulfonate, or from 5 wt % to 30 wt % alkylbenzene sulfonate.

In one product context, the particle may be used in a granular detergent or derivative product thereof. The particle may have a particle size distribution such that the D50 is from greater than about 150 micrometers to less than about 1700 micrometers. The particle may have a particle size distribution such that the D50 is from greater than about 212 micrometers to less than about 1180 micrometers. The particle may have a particle size distribution such that the D50 is from greater than about 300 micrometers to less than about 850 micrometers. The particle may have a particle size distribution such that the D50 is from greater than about 350 micrometers to less than about 700 micrometers. The particle may have a particle size distribution such that the D20 is greater than about 150 micrometers and the D80 is less than about 1400 micrometers. The particle may have a particle size distribution such that the D20 is greater than about 200 micrometers and the D80 is less than about 1180 micrometers. The particle may have a particle size distribution such that the D20 is greater than about 250 micrometers and the D80 is less than about 1000 micrometers. The particle may have a particle size distribution such that the D10 is greater than about 150 micrometers and the D90 is less than about 1400 micrometers. The particle may have a particle size distribution such that the D10 is greater than about 200 micrometers and the D90 is less than about 1180 micrometers. The particle may have a particle size distribution such that the D10 is greater than about 250 micrometers and the D90 is less than about 1000 micrometers.

In another product context, the particle may be used in a bead-like detergent or derivative thereof. The particle may have a particle size distribution such that the D50 is from greater than about 1 mm to less than about 4.75 mm. The particle may have a particle size distribution such that the D50 is from greater than about 1.7 mm to less than about 3.5 mm. The particle may have a particle size distribution such that the D20 is greater than about 1 mm and the D80 is less than about 4.75 mm. The particle may have a particle size distribution such that the D20 is greater than about 1.7 mm and the D80 is less than about 3.5 mm. The particle may have a particle size distribution such that the D10 is greater than about 1 mm and the D90 is less than about 4.75 mm. The particle may have a particle size distribution such that the D10 is greater than about 1.7 mm and the D90 is less than about 3.5 mm.

The particle's size distribution is measured according to applicants' Granular Size Distribution Test Method.

The particle may comprise from about 10 wt % to about 80 wt % detergent builder, preferably from about 20 wt % to about 60 wt %, preferably from about 30 wt % to about 50 wt %. The particle may comprise from about 2 wt % to about 40 wt % buffering agent, preferably from about 5 wt % to about 30 wt %, preferably from about 10 wt % to about 20 wt %.

The particle may comprise from about 2 wt % to about 20 wt % chelant, preferably from about 5 wt % to about 10 wt %.

The particle may comprise from about 2 wt % to about 20 wt % dispersant polymer, preferably from about 5 wt % to about 10 wt %.

The particle may comprise from 0.5 wt % to 15 wt % of a soluble film or fiber-structuring polymer. Examples of soluble film or fiber structuring polymers include, but are not limited to, polyvinyl alcohol, polyvinyl pyrillidone, polyethelene oxide, modified starch or cellulose polymers, and mixtures thereof. Such polymers may be present in product recycle streams comprising soluble fiber or film materials, for example unitary dose products comprising pouch material, where it is advantageous to incorporate said recycle materials into the current particle.

The rheology-modified detergent particle may be coated or at least partially coated with a layer composition, for example as disclosed in US2007/0196502. Preferably the layer composition comprises non-surfactant actives. More preferably, said non-surfactant actives are selected from the group consisting builder, buffer and dispersant polymer. Even more preferably, said non-surfactant actives are selected from the group consisting of zeolite-A, sodium carbonate, sodium bicarbonate, and a soluble polycarboxylate polymer. This is especially advantageous when the actives (for non-limiting example AES) are suitable for cleaning in cold-water and/or high hardness wash water conditions. The presence of the actives in the layer promotes the initial dissolution of the cold-water and/or hardness-tolerant chemistry. While not being bound by theory, it is hypothesized that having cold-water and hardness-tolerant chemistries earlier in the order of dissolution can protect the more conventional cleaning actives (for non-limiting example LAS surfactant), resulting in superior overall cleaning performance.

Alkoxylated Alkyl Sulfate Anionic Detersive Surfactant:

The alkoxylated alkyl sulfate (AES) anionic detersive surfactant is preferably an ethoxylated C₁₂-C₁₈ alkyl sulfate having an average degree of ethoxylation of from about 0.5 to about 3.0.

Rheology Modifier:

As used herein, the term “rheology modifier” means a material that interacts with concentrated surfactants, preferably concentrated surfactants having a mesomorphic phase structure, in a way that substantially reduces the viscosity and elasticity of said concentrated surfactant. Suitable rheology modifiers include, but are not limited to, sorbitol ethoxylate, glycerol ethoxylate, sorbitan esters, tallow alkyl ethoxylated alcohol, ethylene oxide-propylene oxide-ethylene oxide (EOₓ₁PO_{y}EOₓ₂) triblock copolymers wherein each of x₁ and x₂ is in the range of about 2 to about 140 and y is in the range of from about 15 to about 70, polyethyleneimine (PEI), alkoxylated variants of PEI, and preferably ethoxylated PEI, N,N,N′,N′-tetraethoxylethylenediamine, and mixtures thereof. The rheology modifier may comprise one of the polymers described above, for example, ethoxylated PEI, in combination with a polyethylene glycol (PEG) having a molecular weight of about 2,000 Daltons to about 8,000 Daltons.

As used herein, the term “functional rheology modifier” means a rheology modifier that has additional detergent functionality. In some cases, a dispersant polymer, described herein below, may also function as a functional rheology modifier. A functional rheology modifier may be present in the detergent particles of the current invention at a level of from about 0.5% to about 20%, preferably from about 1% to about 15%, more preferably from about 2% to about 10% by weight of the composition.

Non-Quaternized Alkoxylated Polyethyleneimine:

The non-quaternized alkoxylated polyalkyleneimine has a polyalkyleneimine core with one or more alkoxy side chains bonded to at least one nitrogen atom in the polyalkyleneimine core.

Typically, the non-quaternized alkoxylated polyalkyleneimine is uncharged.

The non-quaternized alkoxylated polyethyleneimine may have an empirical formula (I) of (PEI)a-(EO)b-R1, wherein a is the average number-average molecular weight (MWPEI) of the polyalkyleneimine core of the alkoxylated polyalkyleneimine and is in the range of from about 100 to about 100,000 Daltons, wherein b is the average degree of ethoxylation in said one or more side chains of the alkoxylated polyalkyleneimine and is in the range of from about 5 to about 40, and wherein R1 is independently selected from the group consisting of hydrogen, C1-C4 alkyl, and combinations thereof.

The non-quaternized alkoxylated polyethyleneimine may have an empirical formula (II) of (PEI)o-(EO)m(PO)n-R2 or (PEI)o-(PO)n(EO)m-R2, wherein o is the average number-average molecular weight (MWPEI) of the polyalkyleneimine core of the alkoxylated polyalkyleneimine and is in the range of from about 100 to about 100,000 Daltons, wherein m is the average degree of ethoxylation in said one or more side chains of the alkoxylated polyalkyleneimine which ranges from about 10 to about 50, wherein n is the average degree of propoxylation in said one or more side chains of the alkoxylated polyalkyleneimine which ranges from about 1 to about 50, and wherein R2 is independently selected from the group consisting of hydrogen, C1-C4 alkyl, and combinations thereof.

The non-quaternized alkoxylated polyethyleneimine may comprise ethoxylate (EO) groups, propoxylate (PO) groups, or combinations thereof, preferably ethoxylate (EO) groups.

The non-quaternized alkoxylated polyethyleneimine is typically non-quaternized at the pH of the concentrated surfactant composition.

The non-quaternized alkoxylated polyethyleneimine may be linear, branched, or combinations thereof, preferably branched. The non-quaternized alkoxylated polyethyleneimine may be an alkoxylated polyethyleneimine (PEI).

Typically, the non-quaternized alkoxylated polyethyleneimine comprises a polyalkyleneimine backbone. The polyalkyleneimine may comprise C₂ alkyl groups, C₃ alkyl groups, or mixtures thereof, preferably C₂ alkyl groups. The non-quaternized alkoxylated polyethyleneimine polymer may have a polyethyleneimine (“PEI”) backbone.

The non-quaternized alkoxylated polyethyleneimine may comprise a polyethyleneimine backbone having a weight average molecular weight of from about 400 to about 1000 Daltons, or from about 500 to about 750 Daltons, or from about 550 to about 650 Daltons, or about 600 Daltons, as determined prior to ethoxylation.

The PEI backbones of the polymers described herein, prior to alkoxylation, may have the general empirical formula:

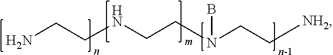

where B represents a continuation of this structure by branching. In some aspects, n+m is equal to or greater than 8, or 10, or 12, or 14, or 18, or 22.

The non-quaternized alkoxylated polyethyleneimine typically comprises alkoxylated nitrogen groups. The non-quaternized alkoxylated polyethyleneimine may independently comprise, on average per alkoxylated nitrogen, up to about 50, or up to about 40, or up to about 35, or up to about 30, or up to about 25, or up to about 20, alkoxylate groups. The non-quaternized alkoxylated polyethyleneimine may independently comprise, on average per alkoxylated nitrogen, at least about 5, or at least about 10, or at least about 15, or at least about 20, alkoxylate groups.

The non-quaternized alkoxylated polyethyleneimine may comprise ethoxylate (EO) groups, propoxylate (PO) groups, or combinations thereof. The non-quaternized alkoxylated polyethyleneimine may comprise ethoxylate (EO) groups. The non-quaternized alkoxylated polyethyleneimine may be free of propoxyate (PO) groups.

The non-quaternized alkoxylated polyethyleneimine may comprise on average per alkoxylated nitrogen, about 1-50 ethoxylate (EO) groups and about 0-5 propoxylate (PO) groups. The non-quaternized alkoxylated polyethyleneimine may comprise on average per alkoxylated nitrogen, about 1-50 ethoxylate (EO) groups and is free of propoxylate (PO) groups. The non-quaternized alkoxylated polyethyleneimine may comprise on average per alkoxylated nitrogen, about 10-30 ethoxylate (EO) groups, preferably about 15-25 ethoxylate (EO) groups.

Suitable polyamines include low molecular weight, water soluble, and lightly alkoxylated ethoxylated/propoxylated polyalkyleneamine polymers. By “lightly alkoxylated,” it is meant the polymers of this invention average from about 0.5 to about 20, or from 0.5 to about 10, alkoxylations per nitrogen. The polyamines may be “substantially noncharged,” meaning that there are no more than about 2 positive charges for every about 40 nitrogens present in the backbone of the polyalkyleneamine polymer at pH 10, or at pH 7; it is recognized, however, that the charge density of the polymers may vary with pH.

Suitable alkoxylated polyalkyleneimines, such as PEI600 EO20, are available from BASF (Ludwigshafen, Germany).

Ethylene Oxide-Propylene Oxide-Ethylene Oxide (EOₓ₁PO_{y}EOₓ₂) Triblock Copolymer:

In the ethylene oxide-propylene oxide-ethylene oxide (EOₓ₁PO_{y}EOₓ₂) triblock copolymer, each of x₁ and x₂ is in the range of about 2 to about 140 and y is in the range of from about 15 to about 70. The ethylene oxide-propylene oxide-ethylene oxide (EOₓ₁PO_{y}EOₓ₂) triblock copolymer preferably has an average propylene oxide chain length of between 20 and 70, preferably between 30 and 60, more preferably between 45 and 55 propylene oxide units.

Preferably, the ethylene oxide-propylene oxide-ethylene oxide (EOₓ₁PO_{y}EOₓ₂) triblock copolymer has a molecular weight of between about 1000 and about 10,000 Daltons, preferably between about 1500 and about 8000 Daltons, more preferably between about 2000 and about 7000 Daltons, even more preferably between about 2500 and about 5000 Daltons, most preferably between about 3500 and about 3800 Daltons.

Preferably, each ethylene oxide block or chain independently has an average chain length of between 2 and 90, preferably 3 and 50, more preferably between 4 and 20 ethylene oxide units.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOₓ₁PO_{y}EOₓ₂) triblock copolymer, where each of x₁ and x₂ is in the range of about 2 to about 140 and y is in the range of from about 15 to about 70, improve cleaning.

Preferably the copolymer has a molecular weight between about 3500 and about 3800 Daltons, a propylene oxide content between 45 and 55 propylene oxide units, and an ethylene oxide content of between 4 and 20 ethylene oxide units per ethylene oxide block.

Preferably, the ethylene oxide-propylene oxide-ethylene oxide (EOₓ₁PO_{y}EOₓ₂) triblock copolymer has a molecular weight of between 1000 and 10,000 Daltons, preferably between 1500 and 8000 Daltons, more preferably between 2000 and 7500 Daltons. Preferably, the copolymer comprises between 10% and 95%, preferably between 12% and 90%, most preferably between 15% and 85% by weight of the copolymer of the combined ethylene-oxide blocks. Some ethylene oxide-propylene oxide-ethylene oxide (EOₓ₁PO_{y}EOₓ₂) triblock copolymer, where each of x₁ and x₂ is in the range of about 2 to about 140 and y is in the range of from about 15 to about 70, improve dissolution.

Suitable ethylene oxide—propylene oxide—ethylene oxide triblock copolymers are commercially available under the Pluronic PE series from the BASF company, or under the Tergitol L series from the Dow Chemical Company. A particularly suitable material is Pluronic PE 9200.

N,N,N′,N′-tetra(2-hydroxyethyl)ethylenediamine:

N,N,N′,N′-tetra(2-hydroxyethyl)ethylenediamine is a suitable functional rheology modifier, which also has chelant activity.

Mixture of Alkoxylated Alkyl Sulfate Anionic Surfactant and Rheology Modifier:

In one aspect, the rheology-modified detergent particle may comprise a pre-mix of a functional rheology modifier and a concentrated surfactant paste comprising alkoxylated alkyl sulfate, providing a substantially molecular (i.e., nano-scale) mixture of the rheology modifier with the surfactant. In this embodiment, the rheology modifier may be added to the surfactant paste within the neutralization loop of the of the surfactant paste making process, said paste being used to make the rheology-modified detergent particle, for example using the paste as a binder in an agglomeration process. In this aspect, additional surfactants, for example, NaLAS, and/or surfactant precursors, for example, HLAS, may be blended directly with the rheology-modified surfactant paste, for example in the neutralization loop, or separately in the agglomeration process; in both cases, the result is a detergent particle with a mixed-active surfactant system.

In another aspect, the rheology-modified detergent particle may comprise a mix of functional rheology modifier with a more finely-divided particulate comprising alkoxylated alkyl suphate, providing a micro-scale mixture of the rheology modifier with the surfactant. For example, the rheology modifier can be used directly as a binder in an agglomeration process. In this example, the particle size distribution of the finely-divided particulate comprising alkoxylated alkyl sulfate must be less than the detergent particle size distribution resulting from the agglomeration process. Typically, the finely-divided particulate has a particle size distribution with the D50 less than about 100 micrometers and the D90 less than 200 micrometers, preferably the D50 less than about 50 micrometers and the D90 less than about 100 micrometers, as measured in applicants' Fine Powder Size Distribution Test.

Surprisingly, the rheology-modified detergent particle is finer and stronger after drying, as compared to the same particle without a rheology modifier. Thus, on the one hand, the rheology-modifier reduces the viscosity of the concentrated aqueous paste used to make the particle, thereby improving paste handling. On the other hand, once the rheology-modified particle is made and dried, the particle is stronger, thereby improving particle storage and handling.

Detergent Builder:

Suitable detergent builders include: zeolite A; layered silicate; carboxymethyl cellulose; modified starch; and any mixture thereof.

Buffering Agent:

Suitable buffering agents include: sodium carbonate; sodium bicarbonate; sodium bisulfate; sodium sesquisulfate; citric acid; maleic acid; adipic acid and any mixture thereof.

Chelant:

Suitable chelants include, but are not limited to, sodium citrate, tetrasodium carboxylatomethyl-glutamate (Dissolvine® or GLDA), trisodium methylglycinediacetate (Trilon® M or MGDA), diethylene triamine pentaacetic acid (DTPA), ethylenediamine tetraacetic acid (EDTA), ethylenediamine disuccininate (EDDS), disodium dihydroxy benzenedisulfonate (Tiron), and any combination thereof.

Dispersant Polymer:

Suitable polymers include, but are not limited to, polymeric carboxylates, such as polyacrylates, poly acrylic-maleic co-polymers, and sulfonated modifications thereof, for example, a hydrophobically modified sulfonated acrylic acid copolymer. The polymer may be a cellulosic based polymer, a polyester, a polyterephthalate, a polyethylene glycol, an ethylene oxide-propylene oxide-ethylene oxide (EOₓ₁PO_{y}EOₓ₂) triblock copolymer, where each of x₁ and x₂ is in the range of about 2 to about 140 and y is in the range of from about 15 to about 70, a polyethyleneimine, any modified variant thereof, such as polyethylene glycol having grafted vinyl and/or alcohol moieties, and any combination thereof. In some cases, the dispersant polymer may also function as a rheology modifier, as described above.

Suitable polyethyleneimine polymers include propoxylated polyalkylenimine (e.g., PEI) polymers. The propoxylated polyalkylenimine (e.g., PEI) polymers may also be ethoxylated. The propoxylated polyalkylenimine (e.g., PEI) polymers may have inner polyethylene oxide blocks and outer polypropylene oxide blocks, the degree of ethoxylation and the degree of propoxylation not going above or below specific limiting values. The ratio of polyethylene blocks to polypropylene blocks (n/p) may be from about 0.6, or from about 0.8, or from about 1, to a maximum of about 10, or a maximum of about 5, or a maximum of about 3. The n/p ratio may be about 2. The propoxylated polyalkylenimines may have PEI backbones having weight average molecular weights (as determined prior to alkoxylation) of from about 200 g/mol to about 1200 g/mol, or from about 400 g/mol to about 800 g/mol, or about 600 g/mol. The molecular weight of the propoxylated polyalkylenimines may be from about 8,000 to about 20,000 g/mol, or from about 10,000 to about 15,000 g/mol, or about 12,000 g/mol.

Suitable propoxylated polyalkylenimine polymers may include compounds of the following structure:

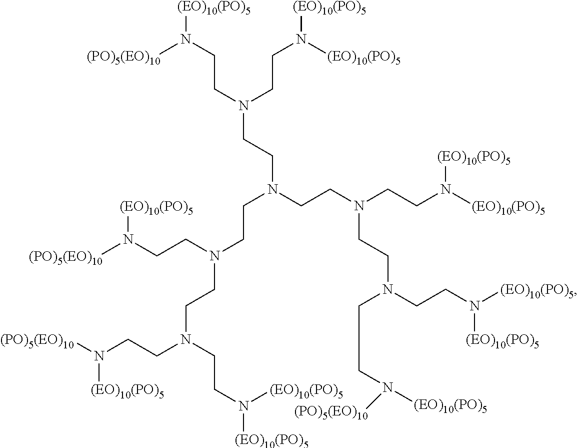

where EOs are ethoxylate groups and POs are propoxylate groups. The compound shown above is a PEI where the molar ratio of EO:PO is 10:5 (e.g., 2:1). Other similar, suitable compounds may include EO and PO groups present in a molar ratio of about 10:5 or about 24:16.

Film or Fiber Structuring Polymer:

Suitable fiber-structuring polymers include: (a) polyvinyl alcohol; (b) polyethylene oxide; (c) cellulosic polymer; (d) modified starch; (e) polyacrylamide; (f) polyvinylpyrollidone; and (g) any combination thereof.

Laundry Detergent Powder Composition:

The laundry detergent powder composition typically comprises from 1 wt % to 90 wt % invention particle.

The laundry detergent powder may be dosed into a washing machine via the dispensing drawer or may be dispensed directly into the drum. Suitable drum dispensing means include granulettes.

Laundry Unit Dose Pouch:

The unit dose laundry pouch typically comprises from 1 wt % to 90 wt % invention particle.

Process:

In a preferred embodiment, a concentrated aqueous paste comprising a mixture of alkoxylated alkyl sulfate anionic detersive surfactant and a rheology modifier, preferably a functional rheology modifier, is used to make the rheology-modified detergent particle according to a paste-agglomeration process. The paste-agglomeration process comprises the steps of: (a) adding powder raw ingredients into a mixer-granulator, where the powder raw ingredients may comprise one or more dry builder, buffer, dispersant polymer or chelant ingredient, necessary powder process aides, and fines recycled from the agglomeration process; (b) adding a paste comprising a premix of concentrated surfactant and functional rheology modifier; (c) of running the mixer-granulator to provide a suitable mixing flow field to disperse the paste with the powder and form agglomerates; optionally, (d) adding additional powder ingredients to at least partially coat the agglomerates, rendering their surface less sticky; (e) optionally drying the resultant agglomerates in a fluidized-bed dryer to remove excess moisture; (f) optionally cooling agglomerates in a fluidized bed cooler; (g) removing any excess fine particles from the agglomerate particle size distribution, preferably by elutriation from the fluidized beds of steps e and/or f, and recycling fines back to step a; (h) removing excess oversize particles from the agglomerate particle size distribution, preferably by screen classification; (i) grinding the oversize particles and recycling the ground particles to step a, e, or f. Examples of suitable paste premix compositions and paste-agglomeration processing are given in the Example section. The paste-agglomeration process may be a batch process or a continuous process.

A variation of the above preferred embodiment may include addition of supplemental LAS cosurfactant in a stream that is separate from the pre-mixed surfactant paste of step (b). Process options include adding pre-neutralized LAS as a solid powder in step (a), adding a neutralized or partially-neutralized LAS paste as a supplement in step (b), or adding a liquid acid precursor (HLAS) as a supplement in step (b). In the latter cases, sufficient free alkalinity must be present in the powders added in step (a) to effectively neutralize the HLAS during the agglomeration process. Alternatively, HLAS neutralization may be done in a separate pre-processing step, first premixing HLAS with alkaine buffer powder ingredients and other optional solid carriers to form a neutralized pre-mix of LAS and alkaline buffer powder in a powder form, and then adding said premix in step (a) above.

In another embodiment using a concentrated aqueous paste comprising a mixture of alkoxylated alkyl sulfate anionic detersive surfactant and a rheology modifier, an extrusion process may be used. The extrusion process comprises the steps of (a) optionally adding fine powder to said paste, dispersing the powder into the paste to form a stiffer paste; (b) extruding the paste mixture through die plate openings of suitable size for the desired particle size, forming extrudates; (c) dividing said extrudates into particles by direct cutting of extrudates upon their exit from the die opening or by breakage in an agitated mixer following the extrusion process; (d) optionally rounding the particles in a spheronization process to form sphere-like particles; (e) optionally drying the resultant particles in a fluidized-bed dryer to remove excess moisture; (f) optionally cooling particles in a fluidized bed cooler; (g) removing any excess fine particles from the particle size distribution, preferably by elutriation from the fluidized beds of steps e and/or f, and recycling fines back to step a; (h) removing excess oversize particles from the particle size distribution, preferably by screen classification; (i) grinding the oversize particles and recycling the ground particles to step a, e, or f. Particles may optionally be coated or partially coated in any number of processes known in the art, for example US2007/0196502.

In yet another embodiment, the rheology modifier may be used as a binder in an agglomeration process to make the rheology modified detergent particle. This binder-agglomeration process comprises the steps of: (a) adding powder raw materials into a mixer-granulator wherein the powder comprises alkoxylated alkyl sulfate anionic detersive surfactant in a fine powder form, optionally with additional dry builder, buffer, dispersant polymer or chelant ingredients, necessary powder process aides, and fines recycled from the granulation process; (b) adding a binder comprising a suitable rheology modifier or mixture thereof; (c) of running the mixer-granulator to provide a suitable mixing flow field to disperse the binder with the powder, forming agglomerates; optionally, (d) adding additional non-surfactant powder ingredients to at least partially coat the agglomerates, rendering their surface less sticky; (e) optionally drying the resultant agglomerates in a fluidized-bed dryer to remove excess moisture; (f) optionally cooling agglomerates in a fluidized bed cooler; (g) removing any excess fine particles from the agglomerate particle size distribution, preferably by elutriation from the fluidized beds of steps e and/or f, and recycling fines back to step a; (h) removing any excess oversize particles from the agglomerate particle size distribution, preferably by screen classification; (i) grinding the oversize particles and recycling the ground particles to step a, e, or f. In this embodiment, achieving adequate micro-mixing of the functional rheology modifier with the alkoxylated alkyl sulfate anionic detersive surfactant requires that the initial particle size of the powder material comprising surfactant has a D50 particle size less than about 100 micrometers and a D90 particle size less than about 200 micrometers, more preferably a D50 particle size less than about 50 micrometers and a D90 particle size less than about 100 micrometers. A pre-grinding step may be added to achieve a finer surfactant-containing powder material. In order to facilitate said grinding, surfactant-containing materials may be combined with other dry materials such as builders and buffers. Alternatively, cryogenic grinding of surfactant-containing materials may be used. Examples of particles made using this process are given in the Example section.

Concentrated Surfactant Paste:

Concentrated surfactant pastes are intermediate compositions that may be combined with other ingredients to form a rheology modified detergent particle of the current invention. Concentrated surfactant compositions may comprise, may consist essentially of, or may consist of the following components: a surfactant system that may include an alkyl alkoxylated sulfate surfactant; a rheology modifier, as described herein; an organic solvent system; and water. These components are described in more detail below.

The concentrated surfactant composition may comprise: from about 70% to about 90%, by weight of the composition, of a surfactant system, where the surfactant system comprises from about 50%, or from about 60%, or from about 70%, or from about 80%, to about 100%, of alkyl alkoxylated sulfate surfactant; from about 0.1% to about 25%, by weight of the composition, of a rheology modifier; less than about 5%, by weight of the composition, of an organic solvent system; and water. The surfactant system of the paste preferably includes LAS co-surfactant. If LAS is included in the surfactant system, the ratio of LAS:AES may be from about 0 to about 1, preferably from about 0.2 to about 0.7, more preferably from about 0.25 to about 0.35.

Solid Carrier:

Suitable solid carriers include inorganic salts, such as sodium carbonate, sodium sulfate and mixtures thereof. Other preferred solid carriers include aluminosilicates, such as zeolite, dried dispersant polymer in a fine powder form, and absorbent grades of fumed or precipitated silica (for example, precipitated hydrophilic silica commercialized by Evonik Industries AG under the trade name SN340). Mixtures of solid carrier materials may also be used.

Formulation of Solid-Form Detergent Products:

The solid-form detergent product may comprise one or more rheology-modified detergent particles in addition to other detergent adjuncts.

In one aspect, the solid-form detergent is in the form of a heavy-duty granular (HDG) detergent product. The HDG product comprises rheology-modified detergent particles, optionally in an admixture with other detergent particulates. The composition of cleaning actives in the granular detergent product can be adjusted according to the mass fraction of rheology-modified detergent particles comprising the cleaning actives as well as the concentration of the cleaning actives in the rheology-modified detergent particles.

In another aspect, the solid-form detergent is in the form of a bead-like particulate product, the bead-like particulates comprising at least a portion of rheology-modified detergent particles. The bead-like particulate product may provide desired product dosing, for example as described in US2007/0196502.

In another aspect, the solid-form detergent is in the form of a unitary dose product wherein the rheology-modified detergent particle may optionally be first admixed with other detergent particulates, and then formed into a tablet, sachet, or soluble-film bounded dose.

Specific contemplated aspects of the disclosure are herein described in the following numbered paragraphs.
1. A rheology-modified detergent particle comprising:
   (a) from about 10 wt % to about 80 wt % alkoxylated alkyl sulfate anionic detersive surfactant;
   (b) from about 0.5 wt % to about 20 wt % of a rheology modifier selected from the group consisting of a non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70, N,N,N′,N′-tetra(2-hydroxyethyl)ethylenediamine, and mixtures thereof.
2. The rheology-modified detergent particle according to paragraph 1 wherein said rheology modifier further comprises polyethylene glycol, wherein said polyethylene glycol has a molecular weight from about 2000 to about 8000 Daltons.
3. The rheology-modified detergent particle according to any of the preceding paragraphs, wherein the alkoxylated alkyl sulfate anionic detersive surfactant is an ethoxylated C₁₂-C₁₈ alkyl sulfate having an average degree of ethoxylation of from about 0.5 to about 3.0.
4. The rheology-modified detergent particle according to any of the preceding paragraphs, wherein the non-quaternized alkoxylated polyethyleneimie has an empirical formula (I) of (PEI)a-(EO)b-R₁, wherein a is the average number-average molecular weight (MWPEI) of the polyalkyleneimine core of the alkoxylated polyalkyleneimine and is in the range of from about 100 to about 100,000 Daltons, wherein b is the average degree of ethoxylation in said one or more side chains of the alkoxylated polyalkyleneimine and is in the range of from about 5 to about 40, and wherein R₁ is independently selected from the group consisting of hydrogen, C₁-C₄ alkyl, and combinations thereof.
5. The rheology-modified detergent particle according to any of the preceding paragraphs wherein the rheology modifier is selected from the group consisting of non-quaternized alkoxylated polyethyleneimie having an empirical formula (I) of (PEI)a-(EO)b-R₁, wherein a is in the range of from about 100 to about 1000 Daltons, preferably 600 Daltons, wherein b is in the range of from about 10 to about 25, preferably about 20, and wherein R₁ is independently selected from the group consisting of hydrogen, C₁-C₄ alkyl, and combinations thereof, an ethylene oxide-propylene oxide-ethylene oxide (EOₓ₁PO_{y}EOₓ₂) triblock copolymer, wherein each of x₁ and x₂ is in the range of about 2 to about 140, preferably about 2 to about 100, more preferably about 2 to about 80, and y is in the range of from about 15 to about 70.
6. A particle according to any of the preceding paragraphs, wherein the weight ratio of alkoxylated alkyl sulfate anionic detersive surfactant to rheology modifier is in the range of from 4:1 to 40:1.
7. A particle according to any of the preceding paragraphs, wherein the ethylene oxide-propylene oxide-ethylene oxide (EOₓ₁PO_{y}EOₓ₂) triblock copolymer has an average propylene oxide chain length of between 20 and 70, preferably between 30 and 60, more preferably between 45 and 55 propylene oxide units.
8. A particle according to any of the preceding paragraphs, wherein the ethylene oxide-propylene oxide-ethylene oxide (EOₓ₁PO_{y}EOₓ₂) triblock copolymer has a molecular weight of between 1000 and 15,000 Daltons, preferably between 1500 and 5000 Daltons, more preferably between 2000 and 4500 Daltons, even more preferably between 2500 and 4000 Daltons, most preferably between 3500 and 3800 Daltons.
9. A particle according to any of the preceding paragraphs, wherein each ethylene oxide block or chain of the ethylene oxide-propylene oxide-ethylene oxide (EOₓ₁PO_{y}EOₓ₂) triblock copolymer independently has an average chain length of between 2 and 90, preferably 3 and 50, more preferably between 4 and 20 ethylene oxide units.
10. A particle according to any of the preceding paragraphs, wherein the ethylene oxide-propylene oxide-ethylene oxide (EOₓ₁PO_{y}EOₓ₂) triblock copolymer comprises between 10% and 90%, preferably between 15% and 50%, most preferably between 15% and 25% by weight of the copolymer of the combined ethylene-oxide blocks.
11. A particle according to any of the preceding paragraphs, wherein the total ethylene oxide content of the ethylene oxide-propylene oxide-ethylene oxide (EOₓ₁PO_{y}EOₓ₂) triblock copolymer is equally split over the two ethylene oxide blocks, preferably each ethylene oxide block comprises on average between 40% and 60%, more preferably between 45% and 55%, even more preferably between 48% and 52%, most preferably 50% of the total number of ethylene oxide units, where the % of both ethylene oxide blocks adds up to 100%.
12. A particle according to any of the preceding paragraphs, wherein the ethylene oxide-propylene oxide-ethylene oxide (EOₓ₁PO_{y}EOₓ₂) triblock copolymer has a molecular weight between 3500 and 3800 Daltons, a propylene oxide content between 45 and 55 propylene oxide units, and an ethylene oxide content of between 4 and 20 ethylene oxide units per ethylene oxide block.
13. A particle according to any of the preceding paragraphs, wherein the particle further comprises alkylbenzene sulfonate.
14. A particle according to any of the preceding paragraphs, wherein the particle has a particle size distribution such that the D50 is from greater than about 150 micrometers to less than about 1700 micrometers.
15. A particle according to any of the preceding paragraphs, wherein the particle has a particle size distribution such that the D50 is from greater than about 1 mm to less than about 4.75 mm
16. A particle according to any of the preceding paragraphs, wherein the particle comprises from about 10 wt % to about 80 wt % detergent builder selected from the group consisting of: zeolite A; layered silicate; carboxymethyl cellulose; modified starch; and any mixture thereof.
17. A particle according to any of the preceding paragraphs, wherein the particle comprises from about 5 wt % to about 40 wt % buffering agent selected from the group consisting of: sodium carbonate; sodium bicarbonate; sodium bisulfate; sodium sesquisulfate; citric acid; and any mixture thereof.
18. A particle according to any of the preceding paragraphs, wherein the particle comprises from about 2 wt % to about 20 wt % chelant selected from the group consisting of: sodium citrate, tetrasodium carboxylatomethyl-glutamate (GLDA), trisodium methylglycinediacetate (MGDA), diethylene triamine pentaacetic acid (DTPA), ethylenediamine tetraacetic acid (EDTA), ethylenediamine disuccininate (EDDS), disodium dihydroxy benzenedisulfonate (Tiron), and any combination thereof.
19. A particle according to any of the preceding paragraphs, wherein the particle comprises from about 2 wt % to about 20 wt % dispersant polymer selected from: polymeric carboxylates; cellulosic based polymer; polyester; polyterephthalate; modified or unmodified polyethylene glycol; an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70; a polyethyleneimine; and any combination thereof.
20. The particle according to any of the preceding paragraphs, wherein said dispersant polymer is selected from the group consisting of polyacrylates, poly acrylic-maleic co-polymers, sulfonated modifications thereof, and mixtures thereof.
21. The particle according to any of the preceding paragraphs, wherein said dispersant polymer is a hydrophobically modified sulfonated acrylic acid copolymer.
22. The particle according to any of the preceding paragraphs, wherein said dispersant polymer is a non-quaternized alkoxylated polyethyleneimine having an empirical formula (II) of (PEI)o-(EO)m(PO)n-R₂ or (PEI)o-(PO)n(EO)m-R₂, wherein o is the average number-average molecular weight (MWPEI) of the polyalkyleneimine core of the alkoxylated polyalkyleneimine and is in the range of from about 100 to about 100,000 Daltons, wherein m is the average degree of ethoxylation in said one or more side chains of the alkoxylated polyalkyleneimine which ranges from about 10 to about 50, wherein n is the average degree of propoxylation in said one or more side chains of the alkoxylated polyalkyleneimine which ranges from about 1 to about 50, and wherein R₂ is independently selected from the group consisting of hydrogen, C₁-C₄ alkyl, and combinations thereof.
23. A particle according to any of the preceding paragraphs, wherein the particle comprises from 0.5 wt % to 15 wt % fiber-structuring polymer, wherein the fiber-structuring polymer is selected from the group consisting of:
   (a) polyvinyl alcohol;
   (b) polyethylene oxide;
   (c) cellulosic polymer;
   (d) modified starch
   (e) polyvinylpyrollidone; and
   (f) any combination thereof.
24. A laundry detergent powder composition comprising from 1 wt % to 90 wt % particle according to any of the preceding paragraphs.
25. A unit dose laundry pouch comprising from 1 wt % to 90 wt % particle according to any of the preceding paragraphs.
26. A process for making a particle according to any of the preceding paragraphs, wherein the process comprises the steps of:
   (a) form an aqueous paste comprising alkoxylated alkyl sulfate anionic detersive surfactant, a rheology modifier, and water; and
   (b) mixing the aqueous paste from step (a) with a solid carrier to form a particle.
27. The process according to any of the preceding paragraphs, wherein said paste has a viscosity of about 0.015 Pa-s to about 10 Pa-s at 1 Pa as determined by The Shear Viscosity Test Method.
28. A process for making a particle according to any of the preceding paragraphs, wherein the process comprises the steps of:
   (a) form an intermediate particulate mixture comprising alkoxylated alkyl sulfate anionic detersive surfactant and solid carrier; and
   (b) mixing the intermediate mixture from step (a) with a rheology modifier to form a particle,
wherein the intermediate particulate mixture introduced into step (b) has a particle size distribution such that the D90 is less than 200 micrometers.

Granular Particle Size Distribution Test:

The granular particle size distribution test is conducted to determine characteristic sizes of rheology-modified detergent particles. It is conducted using ASTM D 502-89, “Standard Test Method for Particle Size of Soaps and Other Detergents”, approved May 26, 1989, with a further specification for sieve sizes and sieve time used in the analysis. Following section 7, “Procedure using machine-sieving method,” a nest of clean dry sieves containing U.S. Standard (ASTM E 11) sieves #4 (4.75 mm), #6 (3.35 mm), #8 (2.36 mm), #12 (1.7 mm), #16 (1.18 mm), #20 (850 micrometer), #30 (600 micrometer), #40 (425 micrometer), #50 (300 micrometer), #70 (212 micrometer), #100 (150 micrometer) is required to cover the range of particle sizes referenced herein. The prescribed Machine-Sieving Method is used with the above sieve nest. A suitable sieve-shaking machine can be obtained from W.S. Tyler Company, Ohio, U.S.A. The sieve-shaking test sample is approximately 100 grams and is shaken for 5 minutes.

The data are plotted on a semi-log plot with the micrometer size opening of each sieve plotted against the logarithmic abscissa and the cumulative mass percent (Q₃) plotted against the linear ordinate. An example of the above data representation is given in ISO 9276-1:1998, “Representation of results of particle size analysis—Part 1: Graphical Representation”, Figure A.4. A characteristic particle size (Dx), for the purpose of this invention, is defined as the abscissa value at the point where the cumulative mass percent is equal to x percent, and is calculated by a straight line interpolation between the data points directly above (a) and below (b) the x % value using the following equation: Dx=10̂[Log(Da)−(Log(Da)−Log(Db))*(Qa−x %)/(Qa−Qb)], where Log is the base 10 logarithm, Qa and Qb are the cumulative mass percentile values of the measured data immediately above and below the x^{th} percentile, respectively; and Da and Db are the micrometer sieve size values corresponding to these data.

Example data and calculations:

| sieve size | | |
|---|---|---|
| (micrometer) | weight on sieve (g) | cumulative mass % finer (CMPF) |
| 4750 | 0 | 100% |
| 3350 | 0 | 100% |
| 2360 | 0 | 100% |
| 1700 | 0 | 100% |
| 1180 | 0.68 | 99.3% |
| 850 | 10.40 | 89.0% |
| 600 | 28.73 | 60.3% |
| 425 | 27.97 | 32.4% |
| 300 | 17.20 | 15.2% |
| 212 | 8.42 | 6.8% |
| 150 | 4.00 | 2.8% |
| Pan | 2.84 | 0.0% |

For D10 (x=10%), the micrometer screen size where CMPF is immediately above 10% (Da) is 300 micrometer, the screen below (Db) is 212 micrometer. The cumulative mass immediately above 10% (Qa) is 15.2%, below (Qb) is 6.8%. D10=10̂[Log(300)−(Log(300)−Log(212))*(15.2%−10%)/(15.2%−6.8%)]=242 micrometer.

For D90 (x=90%), the micrometer screen size where CMPF is immediately above 90% (Da) is 1180 micrometer, the screen below (Db) is 850 micrometer. The cumulative mass immediately above 90% (Qa) is 99.3%, below (Qb) is 89.0%. D90=10̂[Log(1180)−(Log(1180)−Log(850))*(99.3%−90%)/(99.3%−89.0%)]=878 micrometer.

For D50 (x=50%), the micrometer screen size where CMPF is immediately above 50% (Da) is 600 micrometer, the screen below (Db) is 425 micrometer. The cumulative mass immediately above 50% (Qa) is 60.3%, below (Qb) is 32.4%. D50=10̂[Log(600)−(Log(600)−Log(425))*(60.3%−50%)/(60.3%−32.4%)]=528 micrometer.

Fine Powder Size Distribution Test:

The powder size distribution test is conducted to determine the characteristic size of fine powder. The test is done in accordance with ISO 8130-13, “Coating powders—Part 13: Particle size analysis by laser diffraction.” A suitable laser diffraction particle size analyzer with a dry-powder feeder can be obtained from Horiba Instruments Incorporated of Irvine, Calif., U.S.A.; Malvern Instruments Ltd of Worcestershire, UK; Sympatec GmbH of Clausthal-Zellerfeld, Germany; and Beckman-Coulter Incorporated of Fullerton, Calif., U.S.A.

The results are expressed in accordance with ISO 9276-1:1998, “Representation of results of particle size analysis—Part 1: Graphical Representation”, Figure A.4, “Cumulative distribution Q3 plotted on graph paper with a logarithmic abscissa.” The D50 particle size is defined as the abscissa value at the point where the cumulative distribution (Q3) is equal to 50 percent. The D90 particle size is defined as the abscissa value at the point where the cumulative distribution (Q3) is equal to 90 percent.

### Shear Viscosity Test Method

The Shear Viscosity Test Method is used to measure the shear viscosity of fluid specimens as a function of shear rate.

The viscosity test is conducted on a TA instruments Discovery HR-3 rheometer equipped with a 40 mm diameter parallel plate geometry and a Peltier plate is employed. The instrument is controlled via Trios software provided by TA instruments for this purpose. A nominal gap of 1.0 mm is used. The sample is placed on the center of the lower plate and then the upper plate is lowered and brought into contact with the material, while the gap is controlled to approx 1.0 mm. The excess material is then trimmed to ensure consistent sample volume. After the temperature equilibrates to 25° C. for 1 minute, the test ensues. The instrument is programmed to increase stress and measure the resulting viscosity stepwise. TA software calls this a Flow Sweep, and the process is carried out over a range of stress from low 0.1 Pa to high 1000 Pa in a logarithmic format (5 points per decade) using 5 sec. This test is conducted at 25° C., controlled via the Peltier plate temperature control unit used as the lower plate. The motor mode was set to auto in the Trios software, and the equilibration time and averaging time were set to 45 seconds and 15 seconds, respectively.

The test is completed once the upper stress limit is reached. At this point, the instrument stops and the user removes the specimen and cleans the fixture. The data are then plotted as viscosity (Pa-s) versus stress (Pa). Results are reported as the viscosity value measured at 1 Pa.

### Particle Yield Stress Test Methods:

The particle yield stress under compressive force is measured according to following procedure:

A suitable mechanical testing machine, such as INSTRON 3369, with compaction platens and a punch and die set to measure compression up to at least 10 MPa pressure, is used.

Compression Test: Put the bottom punch into the die. Add a sufficient sample of particles into the die, to form a tablet having a height to diameter ratio of from about 0.2 to about 0.5. Add the top punch gently until it rests on the powder. Put the die and punch between the platens of the mechanical testing machine. Move the top platen to less than about 1 mm from the top of the punch. Execute a compressive test to a force that is equivalent to a pressure limit of at least 10 MPa. After compression, retract the platen, remove die and punch, eject the tablet, and measure the height and mass of the tablet.

After above procedure, the compaction curve recoded in the system can be used to calculate yield stress data following below procedure: The compaction curve onset calculation is done by taking tangent lines from particle re-arrangement region to particle deformation region, positioned close to the transition in the curve, and solving for the intersection of the tangents. The first derivative of the compaction curve is used to position the tangent points at each side end of the slope transition. The apparent yield stress can be defined by this onset analysis. Detail data analysis methodology refer to “Analysis and application of powder compaction diagrams,” P. Mort in A. Levy, H. Kalman (Eds.) Handbook of Conveying and Handling of Particulate Solids, Elsevier Science, 2001.

### EXAMPLES

### Example 1: Viscosities of Concentrated Surfactant Pastes

the Viscosities of Several

concentrated surfactant paste compositions are measured; some of the pastes may be used to make particles according to the present disclosure and some may be used to make comparative particles.

Making of Surfactant Pastes:

The surfactant paste compositions are made as follows: the selected rheology modifier and water are added to a scintillation vial and mixed until the rheology modifier is fully dissolved to form a rheology modifier solution; the rheology modifier solution is combined with an ethoxylated alkyl sulfate (AES) solution (AES dissolved in water to the desired concentration, e.g., 21.95%), and sodium carbonate and mixed using a speed mixer cup—mixed for 30 seconds in the FlakTek DAC 500 speedmixer at 3500 rpm; the mixture is then transferred to a glass jar and allowed to stand for 24 hours, to de-gas the mixture.

In the example below, 69.2 g of an AES solution (21.95% active) is added to 8.1 g of a PEG 4000 solution (30% active, PEG 4000 dissolved in water to give 30% activity) and 2.8 g of sodium carbonate. The actual weight fraction of each material is tabulated in the rightmost column

PEG4000/AE1.8S/Sodium Carbonate

| | | | Batch Size | 80.0 | | |
|---|---|---|---|---|---|---|
| | | | (g) | | | |
| | Chemical | Activity | Formula | Amount | Amount | Actual |
| | Name | % | % | Needed (g) | Added (g) | % |
| | DI Water | 100.00% | 74.50% | 0.0 | 0.0 | |
| | PEG 4000 | 30.00% | 3.00% | 8.0 | 8.1 | 3% |
| | solution | | | | | |
| | AE1.8S | 21.95% | 19.00% | 69.2 | 69.2 | 19% |
| | solution | | | | | |
| | Sodium | 100.00% | 3.50% | 2.8 | 2.8 | 4% |
| | Carbonate | | | | | |
| Total | | | | 80.0 | 80.1 | |

The shear viscosity of each paste is measured using The Shear Viscosity Test Method described herein and the viscosity is reported as an average of values taken at low stress. The shear viscosities are shown in the table below. Rheology modifiers marked with an asterisk (*) are shown to reduce viscosity, however these rheology modifiers generally do not provide detergent functionality.

| | | Viscosity |
|---|---|---|
| Rheology modifier (RM) | Paste formulation | Pa-s at 1 Pa |
| None | 21.10% AES, 4% Na₂CO₃ | 145 |
| None | 19% AES, 6% Na₂CO₃ | 93.7 |
| acrylic acid/maleic acid copolymer | 19% AES, 3% RM, 3.50% Na₂CO₃ | 172 |
| Sorbitol | 19% AES, 3% RM, 3.50% Na₂CO₃ | 91.3 |
| Polyethylene Glycol (PEG) 4000* | 19% AES, 3% RM, 3.50% Na₂CO₃ | 0.045 |
| Sodium Toluene Sulfonate (STS)* | 19% AES, 3% RM, 3.50% Na₂CO₃ | 0.11 |
| N,N,N′,N′-tetra(2- | 19% AES, 3% RM, 3.50% Na₂CO₃ | 7.9 |
| hydroxyethyl)ethylenediamine | | |
| PE20¹ | 19% AES, 3% RM, 3.50% Na₂CO₃ | 0.14 |
| Pluronic F38² | 19% AES, 3% RM, 3.50% Na₂CO₃ | 0.03 |
| Tween 20³ | 19% AE1.8S solution, 3% RM, 3.50% Na₂CO₃ | 0.067 |
| Pluronic F68³ | 19% AE1.8S solution, 3% RM, 3.50% Na₂CO₃ | 0.07 |
| Pluronic L92³ | 19% AE1.8S solution, 3% RM, 3.50% Na₂CO₃ | 0.2 |
| Pluronic F77³ | 19% AE1.8S solution, 3% RM, 3.50% Na₂CO₃ | 0.099 |

¹an ethoxylated polyethyleneimine (polyethyleneimine (600 MW), average 20 ethoxylates per NH)
²difunctional block copolymer terminating in primary hydroxyl groups
³polysorbate 20

### Example 2: Concentrated Surfactant Paste Comprising Anionic Surfactant and Rheology Modifier

The following table shows sample formulations of concentrated surfactant compositions used to make particles according to the present disclosure. Amounts are provided as weight percent, by weight of the composition. Ingredients include: AES=alkoxylated alkyl sulfate anionic detersive surfactant, sodium neutralized; LAS=alkyl benzene sulfonate surfactant, sodium-neutralized; rheology modifier=PE20, an ethoxylated polyethyleneimine; Misc includes excess alkalinity, salts and unreacted alcohol.

| Paste | | | Total | rheology | | |
|---|---|---|---|---|---|---|
| composition | AES | LAS | surfactant | modifier | Misc | Moisture |
| 1 | 74.5% | 0.0% | 74.5% | 7.5% | 4.0% | 14.0% |
| 2 | 78.0% | 0.0% | 78.0% | 11.7% | 4.1% | 6.2% |
| 3 | 72.0% | 0.0% | 72.0% | 18.0% | 3.8% | 6.2% |
| 4 | 66.7% | 11.3% | 78.1% | 3.3% | 3.8% | 14.8% |
| 5 | 70.1% | 11.9% | 82.0% | 7.0% | 4.0% | 7.0% |
| 6 | 65.0% | 11.0% | 76.0% | 13.0% | 3.7% | 7.3% |
| 7 | 58.5% | 15.8% | 74.3% | 6.9% | 3.7% | 15.2% |
| 8 | 57.8% | 15.6% | 73.4% | 7.8% | 3.7% | 15.1% |
| 9 | 61.8% | 16.7% | 77.5% | 7.3% | 3.9% | 10.3% |
| 10 | 61.0% | 16.5% | 78.5% | 8.2% | 3.9% | 10.4% |
| 11 | 57.0% | 18.8% | 75.8% | 5.7% | 3.5% | 15.0% |
| 12 | 63.2% | 20.8% | 84.0% | 6.3% | 3.8% | 5.9% |
| 13 | 61.3% | 20.2% | 81.5% | 9.2% | 3.7% | 5.6% |
| 14 | 52.6% | 26.3% | 78.8% | 2.1% | 3.4% | 15.7% |
| 15 | 57.3% | 28.7% | 86.0% | 4.6% | 3.7% | 5.7% |
| 16 | 56.0% | 28.0% | 84.0% | 6.7% | 3.6% | 5.7% |
| 17 | 47.7% | 31.9% | 79.6% | 1.4% | 3.3% | 15.7% |
| 18 | 52.1% | 34.9% | 87.0% | 3.1% | 3.6% | 6.3% |
| 19 | 50.9% | 34.1% | 85.0% | 5.1% | 3.5% | 6.4% |

| | Weight | | | | |
|---|---|---|---|---|---|
| | Percent | MW | | Value of X | Value of Y |
| | EO | PO | Approximate | XEO-YPO- | XEO-YPO- |
| Material | Chain | Chain | MW | XEO | XEO |
| Pluronic F77 | 70 | 2050 | 2050 | | |
| Pluronic L92 | 20 | 2850 | 3650 | 8 | 50 |
| Pluronic F38 | 80 | 950 | 4700 | 43 | 16 |
| Pluronic F68 | 80 | 1750 | 8400 | 76 | 29 |

### Example 3: Rheology-Modified Detergent Particles Made by Paste-Agglomeration

A concentrated paste comprising a mixture of anionic surfactant and ethoxylated polyethyleneimine is used as a binder to agglomerate fine powders including zeolite-A and sodium carbonate, along with recycle fines from the going agglomeration process. Agglomeration is achieved using a suitable binder-agglomeration process. The process may be batch or continuous.

In an example of a batch process, 3.6 kg of zeolite-A powder, 1.5 kg of synthetic light soda ash (i.e., sodium carbonate) and about 2 kg of recycled fines are added to a 9.6 liter dual-axis counter-rotating paddle mixer, for example Model B9.6E-XN available from Dynamic Air Corp. of St. Paul, Minn., USA. While operating the mixer with a paddle tip speed of about 2 m/s, about 3.8 kg of concentrated paste #11 in Example 2, heated to about 60 C, is added though an injection pipe in the converging flow-zone of the mixer (as described in US20170275576) at an injection rate of about 1.5 kg/minute. At about the completion of binder injection, an additional 0.8 kg of fine zeolite powder is added. After completion of binder addition, the mixing time may be extended up to an additional minute before discharging the batch of wet agglomerates into a batch fluid bed dryer.

The fluid bed dryer is operated using an air inlet temperature of about 100 C, with an airflow sufficient to fluidize the particles to a bed height of about 10 to 30 cm, and with a velocity sufficient to elutriate particles up to about 250 um in size. Elutriated particles are separated from the exhaust air-stream and are collected for recycling in the agglomeration process. Meanwhile, the exit air temperature is monitored as a proxy measurement for the moisture content of the particles. When the exit air temperature reaches about 55 C, the heater for the inlet air is turned off; fluidization may continue to allow the product to equilibrate with ambient or even with chilled air before discharging from the fluid bed.

The dried product is then classified using a vibratory screener to remove oversize particles. The oversize fraction may be ground and recycled. The remaining fraction is accepts. The mass balance of the above agglomeration process results in a particle having about 46% zeolite-A hydrate, 17% sodium carbonate, 24% AE1S, 8% LAS, and 2.4% PE20, balance miscellaneous and moisture.

Substituting a more highly concentrated paste #12 in the above example enables higher paste loading in the agglomeration process, with a resultant increase in the particle active level, for example an increase in paste dosing from 3.8 to about 4.4 kg. The mass balance of the more highly-loaded agglomeration process results in a particle having about 42% zeolite hydrate, 15% sodium carbonate, 28% AE1S, 9% LAS, and 2.8% PE20, balance miscellaneous and moisture.

Using the above equipment to make a particle composition with supplemental LAS, a pre-mix step is used to neutralize HLAS as follows: 2.5 kg of HLAS is mixed into 4.8 kg of fine synthetic sodium carbonate (Solvay) and 0.35 kg of precipitated silica (e.g., Evonik SN-340); the resultant premix powder comprises neutralized LAS and excess sodium carbonate that is not consumed in the neutralization reaction. In a subsequent agglomeration step 3.5 kg of concentrated paste #8 is mixed into 2.9 kg of the premix, 0.7 kg of dried dispersant polymer powder (e.g., Acusol 445ND), 1.0 kg of precipitated silica and about 2 kg of recycle fines. An additional 0.15 kg of precipitated silica is added after the paste addition is complete. After drying and classification steps, the resultant product composition has about 46% active surfactant (26% AES, 20% LAS), 21% sodium carbonate, 8.5% dispersive polymer, 3.5% PE20, 17% silica, balance miscellaneous and moisture.

Raw materials used in the above process may be adjusted to include additional detersive actives, for example builder, polymer dispersant and/or chelant materials. Additional dry raw materials, for example CMC particles, polycarboxylate flakes, or chelant powders, may be included in the agglomeration process. Additional aqueous raw materials, for example chelant or polymer solutions, may be added as supplemental binders in the agglomeration process.

### Example 4

Rheology-modified detergent particles made by agglomeration of a fine powder comprising surfactant with a binder comprising a functional rheology modifier.

A fine powder comprising alkoxylated alkyl sulfate anionic detersive surfactant is obtained by micronizing detergent particles comprising AE1S surfactant, or more preferably a blend of AE1S and LAS surfactants. Micronization can be achieved using a suitable milling device, for example a Hammer Mill with a suitably fine retention screen or a rotor-stator Pin Mill. As preferred example, a rotor-stator Pin Mill, for example a Netzsch CUM 150 operating at 11000 RPM and a feed rate of 500 kg/hr of high-active surfactant particles is used to create a fine powder having a D50 particle size less than about 50 um and a D90 less than about 100 um.

Agglomeration is achieved using a suitable binder-agglomeration process. The process may be batch or continuous. In one example of a batch process, 22 kg of finely-micronized powder comprising ˜45 mass % AE1S surfactant, 8 kg of fine zeolite-A powder, and about 10 kg of fines recycled from previous batches are added to a 60 liter dual-axis counter-rotating paddle mixer, for example Model B60-XE available from Dynamic Air Corp. of St. Paul, Minn., USA. While operating the mixer with a paddle tip speed of about 2 m/s, about 6 kg of binder comprising an aqueous solution of PE20 is added though an injection pipe in the converging flow-zone of the mixer at an injection rate of about 5 kg/minute. At about the completion of binder injection, an additional 3 kg of fine zeolite powder is added. After completion of binder addition, the mixing time may be extended up to an additional minute before discharging the batch of wet agglomerates into a batch fluid bed dryer.

The fluid bed dryer is operated using an air inlet temperature of about 100 C, with an airflow sufficient to fluidize the particles to a bed height of about 10 to 30 cm, and with a velocity sufficient to elutriate particles up to about 250 um in size. Elutriated particles are separated from the exhaust air-stream and are collected for recycling in the agglomeration process. Meanwhile, the exit air temperature is monitored as a proxy measurement for the moisture content of the particles. When the exit air temperature reaches about 50 C, the heater for the inlet air is turned off; fluidization may continue to allow the product to equilibrate with ambient or even with chilled air before discharging from the fluid bed. The dried product is then classified using a vibratory screener to remove oversize particles. The oversize fraction may be ground and recycled. The remaining fraction is accepts.

Raw materials used in the above process may be adjusted to include additional detersive actives, for example builder and/or chelant materials. Additional dry raw materials, for example CMC particles, polycarboxylate flakes, or chelant powders, may be co-milled with the surfactant particles. Alternatively, if supplemental dry raw materials are already in a powdered form, they may be added directly in the agglomeration step, bypassing the mill. Supplemental binders may be used to add actives in liquid or solution forms. With these adjustments, a variety of particle compositions can be made, for example as per the following table:

| | A | B | C | D |
|---|---|---|---|---|
| Anionic surfactant | 25-50% | 20-40% | 25-50% | 20-40% |
| Ethoxylated PEI | 5-20% | 5-20% | 5-20% | 5-20% |
| Chelant | 0 | 0 | 2-20% | 2-20% |
| Sodium Carbonate | 10-40% | 10-40% | 10-40% | 10-40% |
| Builder and/or Dispersant | 0 | 10-40% | 0 | 10-40% |
| Polymer* | | | | |
| Balance** | 5-20% | 5-20% | 2-20% | 2-20% |

*Builder and/or Dispersant Polymer may be selected from the group: Carboxymethylcellulose, zeolite-A, polymeric carboxylates such as polyacrylates, poly acrylic-maleic co-polymers, and sulfonated modifications thereof, and mixtures thereof.
**Balance includes any additional actives plus residual moisture, process aids, and trace salt and unreacted alcohols in surfactant paste.

### Example 5

Rheology-modified detergent particles made by agglomeration has smaller particle size and higher yield stress

Following the procedures described in previous examples, the following table shows sample formulations of concentrated surfactant compositions used to make particles according to the present disclosure. Amounts are provided as weight percent, by weight of the composition. Ingredients include: AES=alkoxylated alkyl sulfate anionic detersive surfactant, sodium neutralized; LAS=alkyl benzene sulfonate surfactant, sodium-neutralized; rheology modifier=PE20, an ethoxylated polyethyleneimine; Misc includes excess alkalinity, salts and unreacted alcohol.

| Paste | | | Total | rheology | | |
|---|---|---|---|---|---|---|
| composition | AES | LAS | surfactant | modifier | Misc | Moisture |
| I | 78.0% | 0.0% | 78.0% | 0% | 3.8% | 17.9% |
| (Comparative) | | | | | | |
| II | 78.5% | 0.0% | 78.5% | 3.1% | 3.9% | 14.2% |
| III | 80.5% | 0.0% | 80.5% | 1.2% | 4.0% | 14.0% |
| IV | 58.6% | 19.4% | 78.0% | 0% | 3.1% | 18.4% |
| (Comparative) | | | | | | |
| V | 59.6% | 19.7% | 79.3% | 2.4% | 3.1% | 14.6% |
| VI | 60.5% | 20.0% | 80.5% | 1.2% | 3.2% | 14.5% |

Agglomeration is achieved using a suitable binder-agglomeration process. The process may be batch or continuous. In one example of a batch process, 195.44 g AE1 S surfactant (I), 322.80 g of fine zeolite-A powder, 65 g of sodium carbonate, and about 260 g of fines recycled from previous batches are added to a processall tilt-a-pin mixer run at 1600 rpm for 14 seconds. The Tilt-a-pin mixer is run with a hot water jacket at the temperature of 60 C. This material is then immediately transferred into a Processall Tilt-a-plow mixer run at 240 rpm. Additional 48.86 g of paste is added into the mixer via injection point aiming at the rotating chopper over the course of 5 secs. The additional paste is injected after the powder was mixed for 30 seconds. The chopper inside Tilt-a-plow mixer is run at 1000 rpm. The Tilt-a-plow mixer is run with a hot water jacket at the temperature of 60 C. At about the completion of binder injection, an additional 32.50 g of fine zeolite powder is added. After completion of binder addition, the mixing time may be extended up to an additional 1 minute before discharging the batch of wet agglomerates. The total batch time is about 90 sec in Tilt-a-plow mixer.

The wet agglomerates are put on a tray and dried in an oven for 2 hr at the temperature of 100 C. The remaining dried agglomerate particles contains 29% of total surfactant active.

Following same procedure as above, different surfactant paste (paste II,III,IV,V,VI) are then used to make agglomerate particles to reach same activity (˜29%) and the product particle size are measured as per the following table:

| | I | II | III | IV | V | VI |
|---|---|---|---|---|---|---|
| Total Anionic | ~29% | ~29% | ~29% | ~29% | ~29% | ~29% |
| surfactant | | | | | | |
| Ethoxylated PEI | 0 | 1.15% | 0.4% | 0 | 0.88% | 0.43% |
| Zeolite A | ~55% | ~55% | ~55% | ~55% | ~55% | ~55% |
| Sodium Carbonate | 10% | 10% | 10% | 10% | 10% | 10% |
| Misc. and water | ~5% | ~5% | ~5% | ~5% | ~5% | ~5% |
| Particle size (D50) | 275 | 244 | 213 | 197 | 76 | 104 |

From this table, we can see particles made with paste including rheology modifier are smaller than the one without rheology modifier. Sample II, III are smaller than comparative sample I. Sample V,VI are smaller than comparative sample IV. Smaller particle size are preferred for fast dissolution and avoid residue during dissollution.

Additional agglomerate examples are made with the same paste list above. However, in order to get similar particle size samples to compare particle yield stress, the particle activities was increased for sample IV, V, VI. The agglomerate particle was dried in oven, then sieved. The particle between size cut 250 um and 850 um are used for the yield stress test via Instron.

| | I | II | III | IV-2 | V-2 | VI-2 |
|---|---|---|---|---|---|---|
| Total Anionic | ~29% | ~29% | ~29% | ~32% | ~32% | ~32% |
| surfactant | | | | | | |
| Ethoxylated PEI | 0 | 1.15% | 0.4% | 0 | 0.97% | 0.47% |
| Zeolite A | ~55% | ~55% | ~55% | ~53% | ~52% | ~53% |
| Sodium Carbonate | 10% | 10% | 10% | 10% | 10% | 10% |
| Misc and water | ~5% | ~5% | ~5% | ~5% | ~5% | ~5% |
| Particle yield | 0.16 | 0.55 | 0.36 | 0.5 | 0.8 | 0.76 |
| stress (Mpa) | | | | | | |

As shown in this table, it was found that particles made with paste including rheology modifier are surprisingly stronger after drying. Sample II, III have higher yield stress than comparative sample I. Sample V-2,VI-2 have higher yield stress than comparative sample IV-2. High yield stress particles are preferred for better storage and handling properties.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A rheology-modified detergent particle comprising:
(a) from about 10 wt % to about 80 wt % alkoxylated alkyl sulfate anionic detersive surfactant;
(b) from about 0.5 wt % to about 20 wt % of a rheology modifier selected from the group consisting of a non-quaternized alkoxylated polyethyleneimine, wherein said alkoxylated polyalkyleneimine has a polyalkyleneimine core with one or more alkoxy side chains bonded to at least one nitrogen atom in the polyalkyleneimine core, an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70, N,N,N′,N′-tetra(2-hydroxyethyl)ethylenediamine, and mixtures thereof.

2. The rheology-modified detergent particle according to claim 1 wherein said rheology modifier further comprises polyethylene glycol, wherein said polyethylene glycol has a molecular weight from about 2000 to about 8000 Daltons.

3. The rheology-modified detergent particle according to claim 1, wherein the alkoxylated alkyl sulfate anionic detersive surfactant is an ethoxylated C₁₂-C₁₈ alkyl sulfate having an average degree of ethoxylation of from about 0.5 to about 3.0.

4. The rheology-modified detergent particle according to claim 1, wherein the non-quaternized alkoxylated polyethyleneimie has an empirical formula (I) of (PEI)a-(EO)b-R₁, wherein a is the average number-average molecular weight (MWPEI) of the polyalkyleneimine core of the alkoxylated polyalkyleneimine and is in the range of from about 100 to about 100,000 Daltons, wherein b is the average degree of ethoxylation in said one or more side chains of the alkoxylated polyalkyleneimine and is in the range of from about 5 to about 40, and wherein R₁ is independently selected from the group consisting of hydrogen, C₁-C₄ alkyl, and combinations thereof.

5. The rheology-modified detergent particle according to claim 1 wherein the rheology modifier is selected from the group consisting of non-quaternized alkoxylated polyethyleneimie having an empirical formula (I) of (PEI)a-(EO)b-R₁, wherein a is in the range of from about 100 to about 1000 Daltons, preferably 600 Daltons, wherein b is in the range of from about 10 to about 25, preferably about 20, and wherein R₁ is independently selected from the group consisting of hydrogen, C₁-C₄ alkyl, and combinations thereof, an ethylene oxide-propylene oxide-ethylene oxide (EOₓ₁PO_{y}EOₓ₂) triblock copolymer, wherein each of x₁ and x₂ is in the range of about 2 to about 140 and y is in the range of from about 15 to about 70, and N,N,N′,N′-tetraethoxylethylenediamine.

6. A particle according to claim 1, wherein the weight ratio of alkoxylated alkyl sulfate anionic detersive surfactant to rheology modifier is in the range of from 4:1 to 40:1.

7. A particle according to claim 1, wherein the ethylene oxide-propylene oxide-ethylene oxide (EOₓ₁PO_{y}EOₓ₂) triblock copolymer has an average propylene oxide chain length of between 20 and 70, preferably between 30 and 60, more preferably between 45 and 55 propylene oxide units.

8. A particle according to claim 1, wherein the ethylene oxide-propylene oxide-ethylene oxide (EOₓ₁PO_{y}EOₓ₂) triblock copolymer has a molecular weight of between 1000 Daltons and 15,000 Daltons, preferably between 1500 Daltons and 5000 Daltons more preferably between 2000 Daltons and 4500 Daltons, even more preferably between 2500 Daltons and 4000 Daltons, most preferably between 3500 Daltons and 3800 Daltons.

9. A particle according to claim 1, wherein each ethylene oxide block or chain of the ethylene oxide-propylene oxide-ethylene oxide (EOₓ₁PO_{y}EOₓ₂) triblock copolymer independently has an average chain length of between 2 and 90, preferably 3 and 50, more preferably between 4 and 20 ethylene oxide units.

10. A particle according to claim 1, wherein the ethylene oxide-propylene oxide-ethylene oxide (EOₓ₁PO_{y}EOₓ₂) triblock copolymer comprises between 10% and 90%, preferably between 15% and 50%, most preferably between 15% and 25% by weight of the copolymer of the combined ethylene-oxide blocks.

11. A particle according to claim 1, wherein the total ethylene oxide content of the ethylene oxide-propylene oxide-ethylene oxide (EOₓ₁PO_{y}EOₓ₂) triblock copolymer is equally split over the two ethylene oxide blocks, preferably each ethylene oxide block comprises on average between 40% and 60%, more preferably between 45% and 55%, even more preferably between 48% and 52%, most preferably 50% of the total number of ethylene oxide units, where the % of both ethylene oxide blocks adds up to 100%.

12. A particle according to claim 1, wherein the ethylene oxide-propylene oxide-ethylene oxide (EOₓ₁PO_{y}EOₓ₂) triblock copolymer has a molecular weight between 3500 Daltons and 3800 Daltons, a propylene oxide content between 45 and 55 propylene oxide units, and an ethylene oxide content of between 4 and 20 ethylene oxide units per ethylene oxide block.

13. A particle according to claim 1, wherein the particle further comprises alkylbenzene sulfonate.

14. A particle according to claim 1, wherein the particle has a particle size distribution such that the D50 is from greater than about 150 micrometers to less than about 1700 micrometers.

15. A particle according to claim 1, wherein the particle has a particle size distribution such that the D50 is from greater than about 1 mm to less than about 4.75 mm.

16. A particle according to claim 1, wherein the particle comprises from about 10 wt % to about 80 wt % detergent builder selected from the group consisting of: zeolite A; layered silicate;
carboxymethyl cellulose; modified starch; and any mixture thereof.

17. A particle according to claim 1, wherein the particle comprises from about 5 wt % to about 40 wt % buffering agent selected from the group consisting of: sodium carbonate; sodium bicarbonate; sodium bisulfate; sodium sesquisulfate; citric acid; and any mixture thereof.

18. A particle according to claim 1, wherein the particle comprises from about 2 wt % to about 20 wt % chelant selected from the group consisting of: sodium citrate, tetrasodium carboxylatomethyl-glutamate (GLDA), trisodium methylglycinediacetate (MGDA), diethylene triamine pentaacetic acid (DTPA), ethylenediamine tetraacetic acid (EDTA), ethylenediamine disuccininate (EDDS), disodium dihydroxy benzenedisulfonate (Tiron), and any combination thereof.

19. A particle according to claim 1, wherein the particle comprises from about 2 wt % to about 20 wt % dispersant polymer selected from: polymeric carboxylates; cellulosic based polymer; polyester; polyterephthalate; modified or unmodified polyethylene glycol; an ethylene oxide-propylene oxide-ethylene oxide (EOₓ₁PO_{y}EOₓ₂) triblock copolymer wherein each of x₁ and x₂ is in the range of about 2 to about 140 and y is in the range of from about 15 to about 70; a polyethyleneimine; and any combination thereof.

20. The particle according to claim 19, wherein said dispersant polymer is selected from the group consisting of polyacrylates, poly acrylic-maleic co-polymers, sulfonated modifications thereof, and mixtures thereof.

21. The particle according to claim 19, wherein said dispersant polymer is a hydrophobically modified sulfonated acrylic acid copolymer.

22. The particle according to claim 19, wherein said dispersant polymer is a non-quaternized alkoxylated polyethyleneimine having an empirical formula (II) of (PEI)o-(EO)m(PO)n-R₂ or (PEI)o-(PO)n(EO)m-R₂, wherein o is the average number-average molecular weight (MWPEI) of the polyalkyleneimine core of the alkoxylated polyalkyleneimine and is in the range of from about 100 to about 100,000 Daltons, wherein m is the average degree of ethoxylation in said one or more side chains of the alkoxylated polyalkyleneimine which ranges from about 10 to about 50, wherein n is the average degree of propoxylation in said one or more side chains of the alkoxylated polyalkyleneimine which ranges from about 1 to about 50, and wherein R₂ is independently selected from the group consisting of hydrogen, C₁-C₄ alkyl, and combinations thereof.

23. A particle according to claim 1, wherein the particle comprises from 0.5 wt % to 15 wt % fiber-structuring polymer, wherein the fiber-structuring polymer is selected from the group consisting of:
(a) polyvinyl alcohol;
(b) polyethylene oxide;
(c) cellulosic polymer;
(d) modified starch
(e) polyvinylpyrollidone; and
(f) any combination thereof.

24. A laundry detergent powder composition comprising from 1 wt % to 90 wt % particle according to claim 1.

25. A unit dose laundry pouch comprising from 1 wt % to 90 wt % particle according to claim 1.

26. A process for making a particle according to claim 1, wherein the process comprises the steps of:
(a) form an aqueous paste comprising alkoxylated alkyl sulfate anionic detersive surfactant, a rheology modifier, and water; and
(b) mixing the aqueous paste from step (a) with a solid carrier to form a particle.

27. The process of claim 25, wherein said paste has a viscosity of about 0.015 Pa-s to about 10 Pa-s at 1 Pa as determined by The Shear Viscosity Test Method.

28. A process for making a particle according to claim 1, wherein the process comprises the steps of:
(a) form an intermediate particulate mixture comprising alkoxylated alkyl sulfate anionic detersive surfactant and solid carrier; and
(b) mixing the intermediate mixture from step (a) with a rheology modifier to form a particle,
wherein the intermediate particulate mixture introduced into step (b) has a particle size distribution such that the D90 is less than 200 micrometers.
